(19) United States
(12) Patent Application Publication
(10) Pub. No.: US 2026/0059151 A1
(43) Pub. Date: Feb. 26, 2026

(54) CONTEXTUAL SUPPLEMENTAL CONTENT INSERTION AND OPTIMIZATION

(71) Applicant: Disney Enterprises, Inc., Burbank, CA (US)

(72) Inventors: Shuyue Li, Burbank, CA (US); Taryn Nihei, New York, NY (US); Brian Coburn, Los Angeles, CA (US); Timothy Cody, Burbank, NC (US); Darren Jaspan, Burbank, CA (US); Anthony Accardo, Los Angeles, CA (US)

(73) Assignee: Disney Enterprises, Inc., Burbank, CA (US)

(21) Appl. No.: 19/255,949

(22) Filed: Jun. 30, 2025

Related U.S. Application Data
(60) Provisional application No. 63/687,296, filed on Aug. 26, 2024.

(51) Int. Cl. H04N 21/234; H04N 21/442

(52) U.S. Cl. CPC H04N 21/23418; H04N 21/44204

(57) ABSTRACT

In some embodiments, a method stores a set of tags from a taxonomy for a break in main content. A portion of the main content within a time period threshold of the break is analyzed to determine the set of tags. An indication of the break that is going to be experienced during playback of main content is received. A client device is playing back the main content. Responsive to the indication, the set of tags for the break is retrieved. The method provides information for the set of tags to a supplemental content system to facilitate selection of an instance of supplemental content based on the set of tags. The method provides information for the instance of supplemental content to the client device to insert the instance of supplemental content in the break during the playback of the main content.

### CROSS REFERENCE TO RELATED APPLICATIONS

Pursuant to 35 U.S. C. § 119(e), this application is entitled to and claims the benefit of the filing date of U.S. Provisional App. No. 63/687,296 filed Aug. 26, 2024, entitled “CONTEXTUAL SUPPLEMENTAL CONTENT INSERTION AND OPTIMIZATION”, the content of which is incorporated herein by reference in its entirety for all purposes.

### BACKGROUND

Playback of videos may encounter breaks in which supplemental content may be inserted. Previously, entities used their data, third-party licensed data, and publisher data to reach audiences who are best matched to their customer profile or are similar to their existing customers. Matching users based on viewer segments allows entities to deliver their messages to the viewers whose engagement they value most. Not only do entities use offline data from their customer records, but also from vendor data sets, and via publisher audiences to reach their intended viewers.

Matching their own data on customer activity with supplemental content usage data, entities are able to verify the effectiveness of their messaging and their viewer strategies. However, the facility to serve and measure matched supplemental content based on viewer personal data and tracked activity is diminishing due both to continuously intensifying regulations and to increasingly protective distribution platform terms. Already in some areas, it is not possible to match supplemental content using data collected from viewers, such as without explicit user consent.

### BRIEF DESCRIPTION OF THE DRAWINGS

The included drawings are for illustrative purposes and serve only to provide examples of possible structures and operations for the disclosed inventive systems, apparatus, methods, and computer program products. These drawings in no way limit any changes in form and detail that may be made by one skilled in the art without departing from the spirit and scope of the disclosed implementations.

FIG. 1 depicts a simplified system for providing main content and supplemental content according to some embodiments.

FIG. 2 depicts a simplified flowchart of a method for performing contextual tagging according to some embodiments.

FIG. 3 depicts an example of an affinity graph according to some embodiments.

FIG. 4 depicts an example of a process that aggregates contextual tags across instances of main content according to some embodiments.

FIG. 5 depicts a simplified flowchart for creating contextual segments and analyzing usage according to some embodiments.

FIG. 6 depicts an example of contextual segments according to some embodiments.

FIG. 7 depicts an example of analyzing the usage of contextual tags according to some embodiments.

FIG. 8 depicts a simplified system for providing supplemental content matching optimization according to some embodiments.

FIG. 9 depicts a simplified system for processing programmatic requests according to some embodiments.

FIG. 10 depicts a simplified system for enabling contextual tags to be used in a direct sold configuration according to some embodiments.

FIG. 11 illustrates one example of a computing device according to some embodiments.

### DETAILED DESCRIPTION

Described herein are techniques for a content delivery system. In the following description, for purposes of explanation, numerous examples and specific details are set forth to provide a thorough understanding of some embodiments. Some embodiments as defined by the claims may include some or all the features in these examples alone or in combination with other features described below, and may further include modifications and equivalents of the features and concepts described herein.

### System Overview

A system uses a contextual matching process that allows supplemental content to be matched to instances of main content. Supplemental content that may be content inserted in main content and may be, but not limited to, in-stream promos, live events, advertisements, or other types of supplemental content. The contextual matching process may allow supplemental content to be inserted into breaks of instances of main content where the supplemental content may be contextually relevant to main content around the break, such as main content within a threshold around the break. The contextual matching process may not use user account specific characteristics from a user account that is viewing the instance of main content. In contrast to matching with characteristics of user accounts, entities can match their supplemental content to contexts that are found in the instances of main content.

The system may use machine learning contextual tagging to automatically generate contextual tags for main content around breaks. The contextual tags are then used by the system to provide contextual matching for inserting supplemental content in the breaks. The system also categorizes, enriches, and aggregates contextual tags for insertion of supplemental content. Then, the system uses the contextual tags to provide insertion of supplemental content in different types of system configurations.

The use of contextual tags provides many improvements when inserting supplemental content in breaks. For example, the contextual tags may improve the speed at which supplemental content systems can determine instances of supplemental content for a break. The speed may be important because there is a short amount of time to determine instances of supplemental content when a break in the playback of main content is going to occur. The speed is improved because the context may already be analyzed in portions of main content before the break, and the contextual tags can be used to select the instances of supplemental content for the break. The contextual tags may also use less storage. For example, the contextual tags provide a concise description of the context or story arc before a break and can be stored efficiently. Also, in delivery systems, such as video on demand, contextual tags are identified in an offline manner to enable faster processing by the supplemental content system. This allows the supplemental content system to not perform that function enabling dynamic and faster real-time decisions and vastly reduced storage on the supplemental content system.

### System

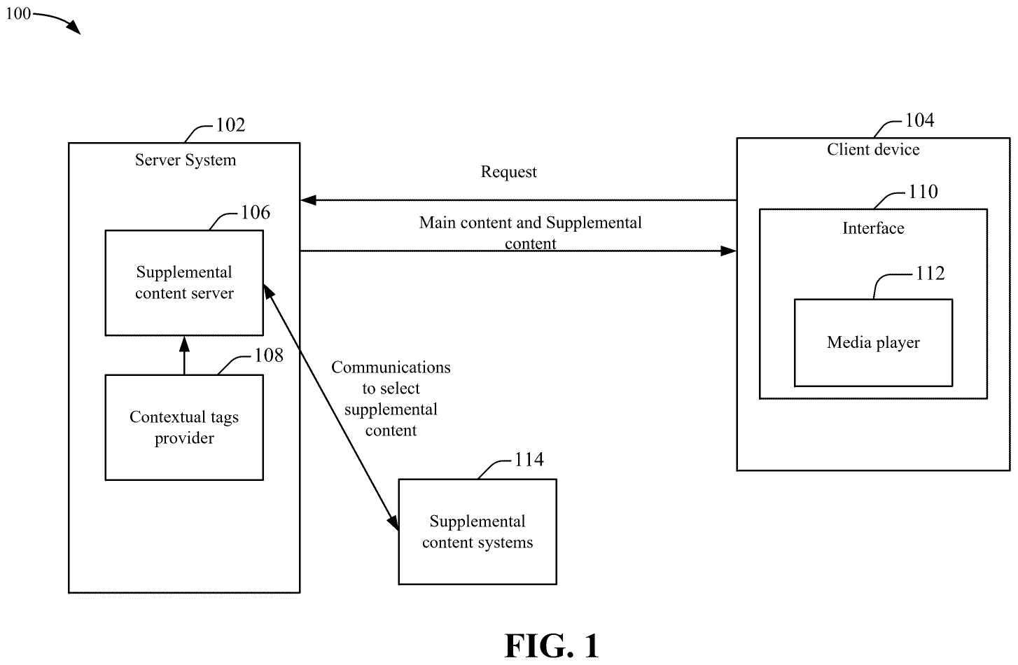

FIG. 1 depicts a simplified system 100 for providing main content and supplemental content according to some embodiments. System 100 includes a server system 102 and a client device 104. Although single instances of server system 102 and client device 104 are shown, multiple instances of server system 102 and client device 104 may be appreciated. For example, multiple client devices 104 may be requesting main content from a single server system 102 or multiple server systems 102.

Server system 102 may facilitate the delivery of main content to client device 104. For example, server system 102 may communicate with multiple content delivery networks (not shown) to have main content delivered to multiple client devices 104. A content delivery network includes servers that can deliver main content to client device 104. The content may be video, audio, or other types of content. Video may be used for discussion purposes, but other types of content may be used in place of video. In some embodiments, a content delivery network delivers segments of video to client device 104. The segments may be a portion of the video, such as six seconds of the video.

Client device 104 may include a mobile phone, smartphone, set top box, television, living room device, tablet device, or other computing device. Client device 104 may include a media player 110 that is displayed on an interface 112. Media player 110 or client device 104 may request content from a content delivery network.

Supplemental content server 106 may receive a request for supplemental content during the playback of main content. The main content may be the content that is requested by client device 104, such as a movie, show, etc. The supplemental content may be inserted in a break of the main content. The break may be X seconds or minutes long and multiple instances of supplemental content may be inserted in a break. An instance of main content may have multiple breaks. Although video is described, supplemental content may also be inserted in other ways, such as in a window of a website, a still frame of video (such as an information screen or message, or a still-frame ad, for example), or interactive supplemental content (such as an interactive survey, game, or ad, for example).

Contextual tags provider 108 determines contextual tags for instances of main content and provides the contextual tags to supplemental content server 106. Contextual tags provider 108 may use a machine learning process to detect contextual tags based on multiple modalities of the main content (e.g., video, audio, text, etc.). A contextual tag may be information that describes a context of the main content. The machine learning process may analyze content around a break to determine contextual tags. The content around a break may be within a threshold, such as 60 seconds, 2 minutes, etc. before a break, after a break, or a combination of before and after the break.

When a break is encountered, contextual tags provider 108 may provide contextual tags for the break to supplemental content server 106. Then, supplemental content server 106 provides information to supplemental content systems 114 based on contextual tags. This allows supplemental content systems 114 to provide instances of supplemental content for insertion in the main content. Different configurations of supplemental content systems 114 may be appreciated.

The following will now describe the determination of contextual tags for main content. Then, different configurations of supplemental content systems 114 will be described.

Machine learning Contextual Tagging

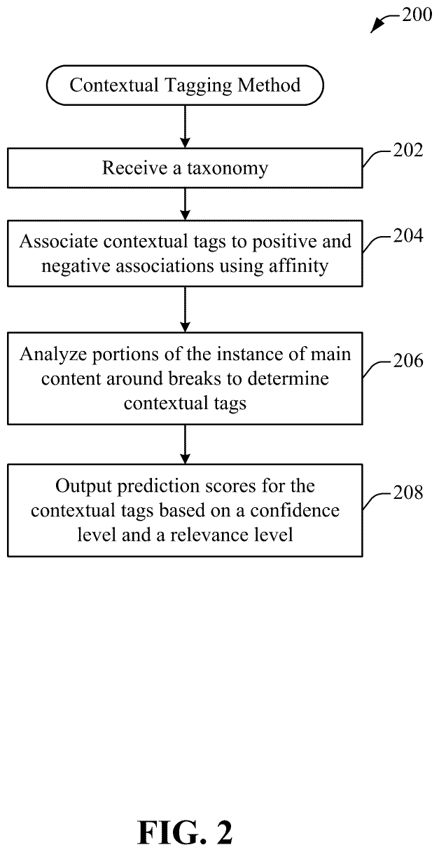

Contextual tags provider 108 may determine contextual tags for instances of main content. In some embodiments, contextual tags provider 108 may use multi-modal processes to extract metadata from main content that is associated with supplemental content breaks. FIG. 2 depicts a simplified flowchart 200 of a method for performing contextual tagging according to some embodiments. The following process may be performed for multiple instances of main content. However, the process will be described for one instance of main content, but the same process can be performed to determine contextual tags for other instances of main content.

At 202, contextual tags provider 108 receives a taxonomy. The taxonomy may be a hierarchical taxonomy that depicts context by a collection of contextual tags. The collection of contextual tags may be used to depict the characteristics of the main content, such as depicting a story arc from segments of main content around a supplemental content break. For example, the main content that is tagged may be from a threshold before a supplemental content break or a threshold after a supplemental content break. The taxonomy may map contextual tags via a hierarchy to different subject matter such that the contextual tags can be used to strategically place supplemental content in the supplemental content breaks.

At 204, once contextual tags provider 108 receives the taxonomy definition, contextual tags provider 108 creates an affinity graph between contextual tags by associating contextual tags to positive and negative associations using affinity. For example, positive affinity may be where main content may positively reflect the supplemental content and negative affinity may negatively affect the supplemental content. In some embodiments, the positive and negative associations may ensure brand safety, such as a fast food restaurant entity might want to insert supplemental content next to an eating contextual tag; however, the entity may want to exclude the instances of supplemental content that have been tagged with vomiting as a negative affinity.

At 206, contextual tags provider 108 analyzes portions of the instance of main content around supplemental content breaks to determine contextual tags. Contextual tags provider 108 may detect contextual tags based on multiple modalities of the instance of main content. The multimodal processes may receive the instance of main content with the associated supplemental content markers that define where a supplemental content break is located in the main content. For example, the markers may indicate a break starts at 10:00 minutes and ends at 12:30 minutes. Contextual tags provider 108 may output a collection of contextual tags for the supplemental content breaks based on analyzing portions of the main content before or after the supplemental content breaks. The multimodal approach may perform feature extraction based on audio, text, or visual components of the instance of main content. The ensemble of processes may be executed in tandem to analyze different mediums of the main content to extract context from the content. Contextual tags provider 108 may parse the mode of content, such as dialogue lines, video frames, or video clips, extract features, and classify the features with contextual tags. Then, contextual tags provider 108 may aggregate the results from the different portions of the main content.

For audio context, an ensemble of machine learning models may be used to extract metadata for sound recognition (e.g., voice tone and sound effects), and classification (e.g., music genre and music emotion). For a dialogue context, an ensemble of natural language process (NLP) models may be used to extract sentiment, emotion, and topic classification of dialogue lines. The dialogue can be determined by two methods: automatic speech recognition or respective closed caption metadata files. For visual context, an ensemble of computer vision models may be used to extract metadata based on generic object detection (e.g., localized detection of generic objects in a video frame—such as hamburgers, bicycles, but not specific objects (e.g., sword), image classification (e.g., classifying video frames) and video classification (e.g., classifying video frames). The extracted metadata is used to determine contextual tags that are relevant to the main content.

To detect brand placement in video, an object detection (e.g., computer vision algorithm that detects localized objects) algorithm identifies products or logos that are strategically placed in video content. Entities can strategically place brand artifacts (e.g., signs, billboards, and product labels) or products in video content. The detection algorithm identifies the temporal segments where the brand is placed throughout the main content. To identify these brand segments, the algorithm parses video into images/frames based on a predefined frame rate selection (e.g., 3 frames per second). An object detection machine learning model is applied to each image to identify the location of each object. The model outputs standard localized detection metrics such as the prediction label, bounding box coordinates, bounding box area, and brand label. The model is uniquely trained on images with logos or products that are intended to be clearly identified by the main content's viewers. Using the frame index (or correlated timestamp), the machine learning output is converted to metadata representing the video segments where the placed brand artifacts are located. Adjacent segments are joined if they are within a prescribed distance or tolerance (e.g., 1 second). A relevancy score is derived from the output metrics as an aggregate computation across segments containing a placed brand.

At 208, contextual tags provider 108 outputs prediction scores for the contextual tags based on a confidence score and a relevance score. A relevance score may rate the relevance of the contextual tag to the main content around the supplemental content break. The relevance is how relevant the contextual tag is to the detected main content. A confidence score may rate the confidence in the contextual tag. For example, the confidence score may rate how confident the system is in the main content including content associated with the contextual tag. Contextual tags provider 108 may select a subset of the contextual tags in the taxonomy and provide prediction scores for those contextual tags. Alternatively, contextual tags provider 108 may output prediction scores for all contextual tags in the taxonomy. Then, contextual tags provider 108 may select some of the contextual tags, such as based on a prediction score meeting a threshold.

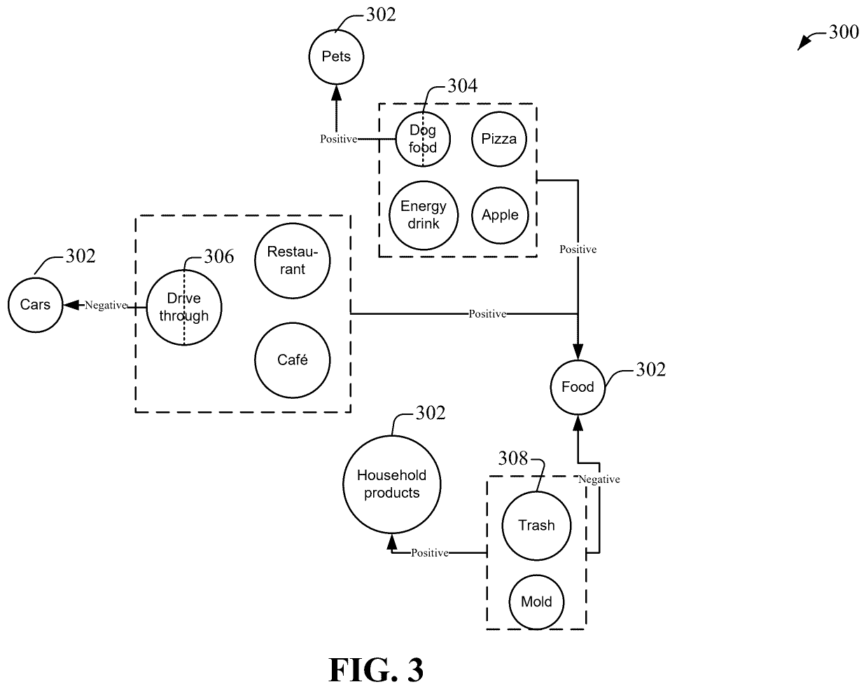

As discussed above, contextual tags provider 108 creates an affinity graph between the contextual tags. FIG. 3 depicts an example of an affinity graph 300 according to some embodiments. Based on the taxonomy, contextual tags provider 108 may have parent level categories. In this example, the parent level categories are shown at 302 of pets, food, cars, and household products. Contextual tags provider 108 associates contextual tags to parent level categories. For example, the contextual tags detected for a break are associated with parent level categories. The association may be classified with an affinity, such as a strong affinity or a weak affinity. The affinity may be determined using different methods. For example, contextual tags provider 108 may analyze the association and automatically determine the affinity, such as using a model that receives the categories and outputs the affinities. Also, affinities may be received from user input. The contextual tags may describe different contexts, such as locations, objects, dialogue, actions, etc. in the main content. In some examples, the contextual tags may be grouped by parent level categories, such as the contextual tags of dog food, pizza, energy drink, and apple are grouped with pets and trash and mold are grouped with household products.

An example of a contextual tag is “dog food”. At 304, the contextual tag of dog food has a strong affinity for the parent category of pets, but a weak affinity for the parent category of food. This is because dog food is normally associated positively with pets, but negatively as human food. The split affinity is shown by a dotted line in the middle of the circle. Similarly, at 306, drive-through has a strong affinity with the parent category of food, but a weak affinity to the parent category of cars. Here, drive-through is normally associated with food, but not so much with the driving of cars.

The strong affinity and weak affinity between contextual tags may help supplemental content server 106 adjust inventory within the parent categories. Contextual tags provider 108 can define strong categories to only include terms that have strong affinities, which will have less inventory volume; and weak categories to include weak affinity contextual tags to expanded inventory. In addition, the affinity map can also serve as a basis for recommendation matching. The system can recommend strongly associated instances of main content to entities when selecting a given contextual tag.

Contextual tags provider 108 may also assign contextual tags positive associations or negative associations. The positive associations or negative associations may be linked to contextual tags that are linked to parent categories. For example, the contextual tag “trash” at 308 is a positive association for the household products category, but a negative association for the food parent category. Positive associations and negative associations may be used to ensure brand safety. For example, a fast food restaurant entity might want to insert supplemental content next to an eating contextual tag; however, the entity might want to exclude inserting supplemental content and breaks that have been tagged with the vomiting contextual tag.

### Break Analysis

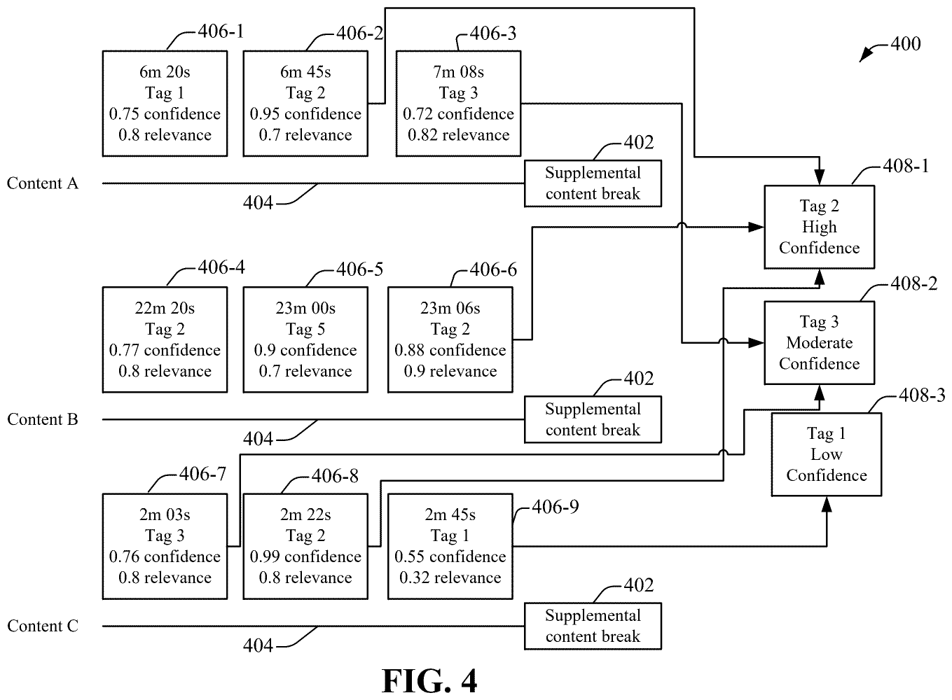

The following will describe the process of analyzing portions of instances of main content around supplemental content breaks in more detail. Although the analysis is discussed with respect to supplemental content breaks, the analysis may be performed around other breaks. For example, a break may be a pause of playback. To determine contextual tags around the pause, the entire length of the content may be analyzed in advance. The contextual tags may be associated with time markers across the entirety of the content, not just the breaks. Alternatively (or in addition), when a pause is detected, the content around the pause may be dynamically analyzed for contextual tags. In the case where supplemental content is inserted during a pause or stop-initiated break in playback, a “seamless” experience may be less important to the viewer, so time spent calculating contextual tags may be less critical to the viewer experience. In the case of such a supplemental content insertion, the supplemental content may be specific to a pause/stop experience, and may range from a still frame of video (such as an information screen or message, or a still-frame ad, for example), to interactive supplemental content (such as an interactive survey, game, or ad, for example). FIG. 4 depicts an example 400 of a process that aggregates contextual tags across instances of main content according to some embodiments. For each supplemental content break, contextual tags provider 108 determines contextual tags for content within a threshold of the time markers for the supplemental content break. In some embodiments, the content that is analyzed may be preceding the supplemental content break for a set time interval, such as 60 seconds, one minute, etc. Also, the main content after the supplemental content break may also be analyzed similarly, but is not described here.

At 402, a supplemental content break is shown for instances of main content A, B, and C. Then at 404, a time interval before the supplemental content break may be analyzed. In some embodiments, contextual tags provider 108 may apply machine learning models to detect contextual tags that can be applied to the supplemental content break as described above. For example, main content A may be input into a model, and predictions of contextual tags are output by the model. In some examples, a tag 1 is output at 406-1, a tag 2 is output at 406-2, and a tag 3 is output at 406-3. The model may also output other information, such as a confidence score or a relevance score. For example, if the model detects a car passing by in the background, the confidence score may be high indicating the model can clearly identify an object as a car. However, the car passing by in the background may not be prominent to this scene and thus may receive a lower relevance score. In contrast, a car that is the main focus of the scene may receive a higher relevance score. The determination of the confidence and relevance score may be categorized, such as in low, high, and moderate categories. In some embodiments, a score higher than 0.9 may be labeled as high, a score between 0.7 and 0.9 is moderate, and a score lower than 0.7 is low.

Other instances of main content B and main content C may also have contextual tags at 406-4, 406-5, and 406-6 and 406-7, 406-8, and 406-9, respectively. Contextual tags provider 108 may also aggregate the tags from multiple instances of main content. For example, tag 1, tag 2, and tag 3 may be aggregated for multiple instances of main content. For example, at 408-1, tag 2 has been aggregated where the confidence is high. Also, tag 2 occurs in all three instances of main content. At 408-2, tag 3 occurs in main content A and main content C with a moderate confidence. Also, 408-3, tag 1 occurs in content C with a low confidence. It is noted that content A includes tag 1, but this tag is associated with a moderate confidence so this tag 1 is not aggregated with the tag 1 of content C. These aggregated contextual tags may reference the respective instances of content and be used to identify instances of main content that include the respective aggregated contextual tags.

Once the contextual tags have been determined and aggregated, contextual tags provider 108 may create contextual segments and analyze the usage.

### Contextual Segments and Usage

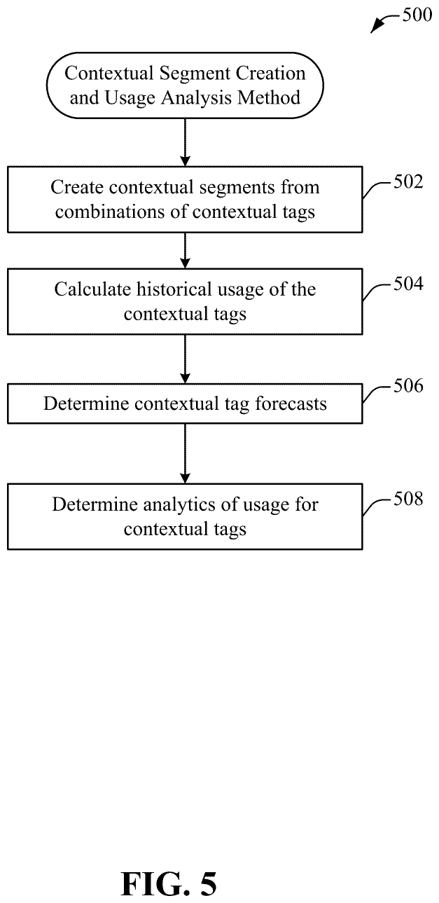

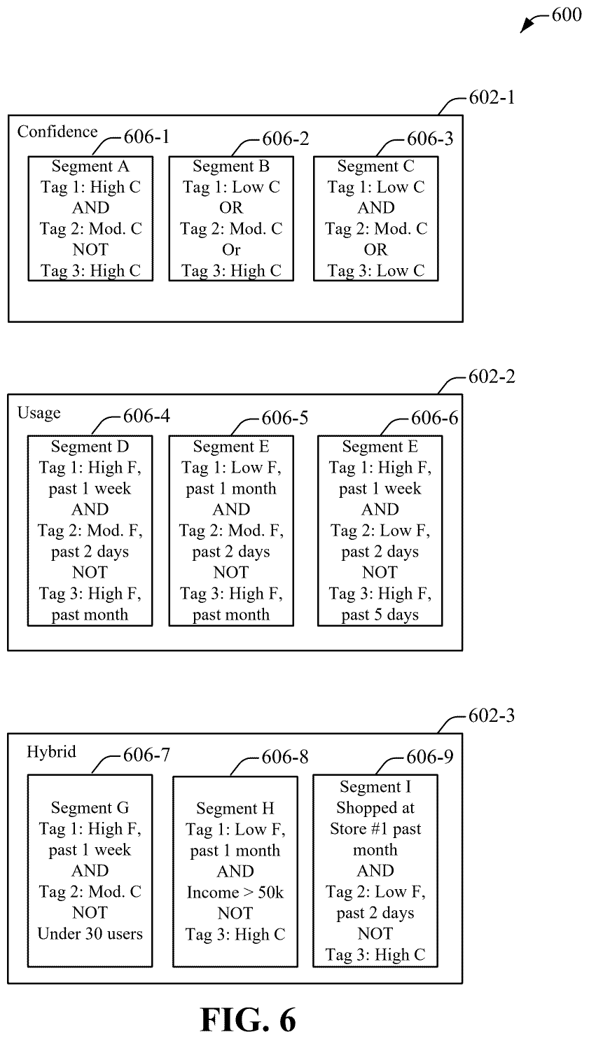

FIG. 5 depicts a simplified flowchart 500 for creating contextual segments and analyzing usage according to some embodiments. At 502, contextual tags provider 108 creates contextual segments from combinations of contextual tags. The contextual segments may be based on different combinations that are defined by operators, such as Boolean operators. The operator may test conditions, such as the confidence or relevance, or indicate the requirement of the main content including or not including the contextual tag. The use of contextual segments is described in more detail in FIG. 6.

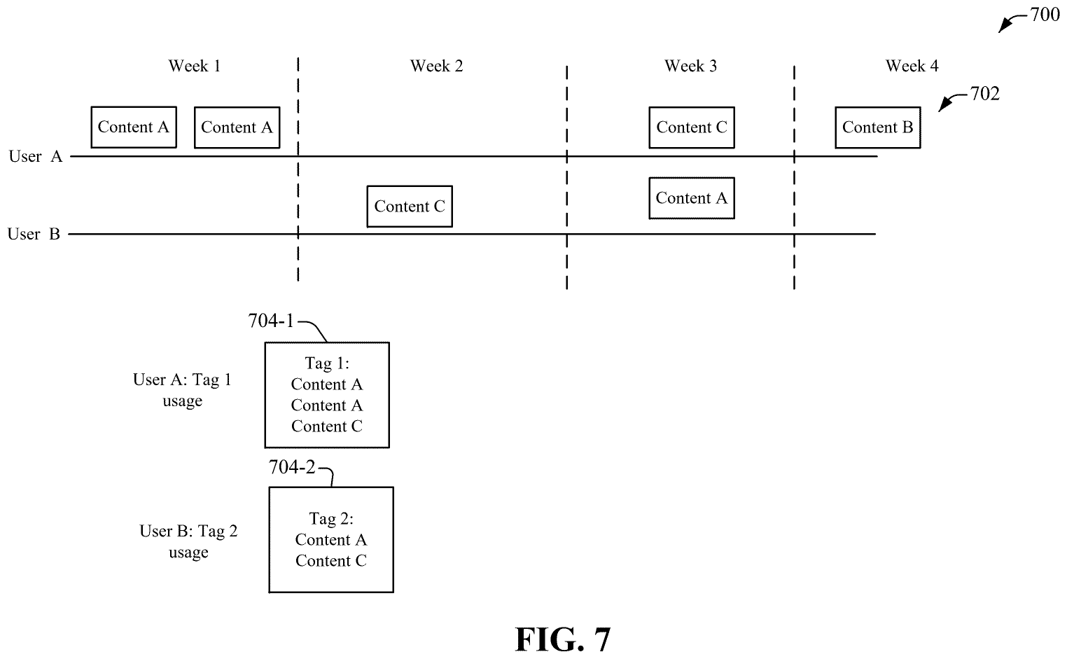

At 504, contextual tags provider 108 calculates the historical usage of the contextual tags. In some examples, contextual tags provider 108 may use the frequency of the contextual tag being seen by user accounts during delivery of the main content. Contextual tags provider 108 may calculate the usage level with each contextual tag. For example, the historical engagement with contextual tags for multiple user accounts may be calculated. FIG. 7 depicts an example of calculating the historical usage in more detail. The historical usage then may be used to create additional contextual segments.

At 506, contextual tags provider 108 determines a contextual tag forecast. For guaranteed delivery, supplemental content server 106 provides an inventory forecast and guarantees the impressions for supplemental content. The inventory forecast may be used to negotiate deals and pricing. Using the historical usage, the inventory may be forecast. For example, Main Content A contains X(1) number of tag 1 across the entire content duration within the predefined time interval preceding each supplemental content break. In the past 30 days, Main Content A was viewed Y(1) times. So, from Main Content A alone, Tag 1 has (X(1) times Y(1)) impressions. Similarly, from Main Content B, Tag 1 has (X(2) times Y(2))impressions. The entire inventory of Tag 1 can be forecasted by adding up its impressions from all main content that contains Tag 1 near its supplemental content breaks.

At 508, contextual tags provider 108 determines analytics of usage for the contextual tags. For example, the actual usage of contextual tags that are viewed by users, can be summarized in analytics, and provided to entities. The entities may use the analytics to place instances of supplemental content with associated contextual tags. Sponsorship entities may have a hard time measuring the effectiveness of the usage of the supplemental content because they do not have tools to verify how many times the sponsored scenes were actually viewed, nor in which content their brands appear most frequently, nor by whom their sponsored content was consumed. Supplemental content server 106 will be able to provide first party (1 p) measurement insights by identifying their brands and products via content tagging, offering basic reach and frequency insights, and adding associated viewer analytics, such as viewer demographic distribution and segment membership to the entities.

To provide analytics, contextual tags provider 108 detects the sponsorship item in the main content. The sponsorship item can be a car, can be a billboard containing the car, can be a hat with the car brand's logo, etc. It can be any form of this brand's product placement. Different from FIG. 4 where contextual tags provider 108 is interested in the tags within a time interval preceding the supplemental content break, here, contextual tags provider 108 scans through the entirety of the main content (Main Content D), looking for any of the sponsorship placements. In some examples, contextual tags provider 108 found three locations within the main content that has a form of this car brand's placement.

Contextual tags provider 108 knows who are the user accounts that have seen Main Content D, and which portion of Main Content D they have actually watched through. In the example, User account A has seen only the first placement; User account B has seen all three; and User account C has seen the last two. This is a total of six impressions. To provide the full analytics for brand sponsorships, contextual tags provider 108 may detect all brand placements in the main content the brand is sponsoring, and then join with full user account playback data to calculate the overall impression and user reach.

The following will now describe examples of contextual segment creation. FIG. 6 depicts an example 600 of contextual segments according to some embodiments. Contextual segments may be based on different conditions, such as confidence at 602-1, usage at 602-2, or a hybrid of conditions at 602-3. A contextual segment 602-1 may include a combination of segments for an entity. For example, a segment A, a segment B, and a segment C are shown. Another set of contextual segments may include contextual segments at 602-2 and another set of contextual segments are shown at 602-3. At 602-1, the segments are defined with confidence values. The tags may be combined in a segment using Boolean operators, but other operators may be appreciated. The operators are associated with conditions. For example, Segment A contains Tag 1 with High Prediction Confidence, AND Tag 2 with Moderate Confidence, but NOT Tag 3 with High Confidence. In this case, the segment will be the intersection of content that includes Tag 1 High Confidence and Tag 2 Moderate Confidence, and excluding content with Tag 3 High Confidence.

At 602-2, the usage may be used to create segments 606-4, 606-5, and 606-6. The usage may be specified in conditions, such as by frequency. A time period may also be added for the frequency, such as within the last day, week, month, 10 days, etc. Contextual tags provider 108 can create user segments based on their viewing behavior in the past. Similar to the 100% contextual segments, the system can allow combinations, such as Boolean combinations, for these user account usage-based segments. For example, contextual tags provider 108 can define Segment D at 606-4 as User accounts who have seen Tag 1 with High Frequency in the past week, AND Tag 2 with moderate frequency in the past 2 days, but have NOT been seeing Tag 3 with high frequency in the past month. Segments 606-5 and 606-6 may be generated with other conditions.

At 602-3, hybrid segments at 606-7, 606-8, and 606-9 may be created using the usage and the confidence. Contextual tags provider 108 can combine contextual matching with usage-based segments. Furthermore, contextual tags provider 108 can also combine the existing non-contextual viewer matching segments with the contextual segments. For example, at 606-7, Tag 1 has been viewed with High Frequence in the past week AND tag 2 with moderate confidence, and NOT by under 30 users. The under 30 may be an age group of the viewer that is not contextual. Segments 606-8 and 606-9 may be generated with other conditions.

FIG. 7 depicts an example 700 of analyzing the usage of contextual tags according to some embodiments. At 702, the historical usage of viewing content main content is shown for a user A and a user B. For example, user A has watched content A twice in week 1, content C in week 3, and content B in week 4. User B has watched content C in week 2 and content A in week 3. Then, contextual tags provider 108 can calculate the frequency of contextual tags being viewed based on this watch history. At 704-1, the frequency of tag 1 being viewed for user A is three times (e.g., in content A twice and content C once) in the past four weeks. Tag 1 showed up once in Content A, 0 times in Content B, and once in Content C. At 704-2, the frequency of user B viewing tag 2 is two times (e.g., in content A and content C). Tag 2 showed up once in Content A, and once in Content C. So, User B has seen Tag 2 twice in the past 4 weeks.

Once the above information is determined, the contextual tags may be used when inserting supplemental content in supplemental content breaks.

### Supplemental Content Insertion

Different configurations of inserting supplemental content may be appreciated. The following may describe three different configurations, such as supplemental content matching optimization, programmatic request insertion of supplemental content, and guaranteed insertion of supplemental content. Although these configurations are described, other configurations may be appreciated. For all three configurations, confidence of the object detection (is this a beer bottle), relevance (how prominent is the beer bottle (2 pixels vs on-screen in the seen clearly visible for 30 seconds), and affinity (is this negative where an advertiser may want to target away) may be determined. For requestable and direct/guaranteed, segments (Fast Food segment which contain contextual tags related to fast food like hamburger, tacos, french fries, etc.) that contain relevant contextual tags and the segment could contain only contextual tags that have a positive sentiment toward fast food and another segment could contain contextual tags that have a negative sentiment toward fast food. These segments could be selected when setting up a campaign to target against. The use of sentiment provides a more seamless viewing experience, which is not as jarring as by having positive and negative sentiment together. The content is not combining moldy bread (which would be negative) with the positives for fast food (hamburger). This also affects the overall experience of consuming the content and the interaction with the content. The viewer may have a negative thoughts about supplemental content.

### Supplemental Content Matching Optimization

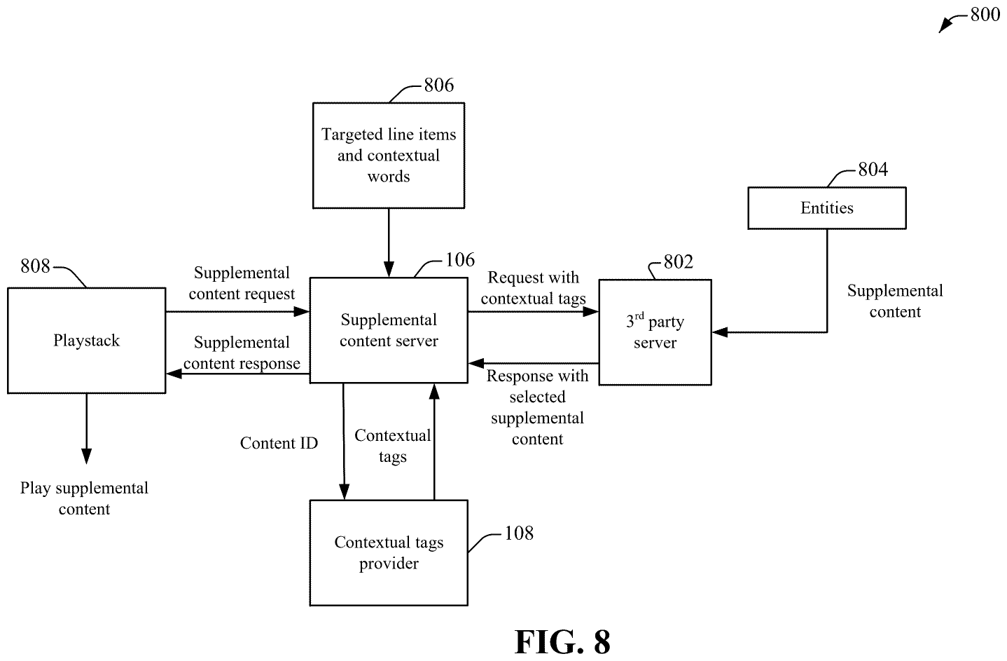

FIG. 8 depicts a simplified system 800 for providing creative matching optimization according to some embodiments. This configuration uses a third-party entity as an example, but other third-party servers may be used. Supplemental content server 106 may communicate to entities what contextual tags are associated with a supplemental content break, and the entities can select instances of supplemental content that are relevant to the contextual tags.

In some examples, supplemental content server 106 may communicate to entities that the supplemental content break is near the content where a family meal is served based on the contextual tags (e.g., contextual tags of eating, food, family, etc.) associated with the supplemental content break. The entities can then select an instance of supplemental content that displays a taco over an instance of supplemental content that includes a cosmetic product. In some embodiments, the contextual tags or categories may be communicated. In other cases, information describing the contextual tags may be sent such that the exact wording of contextual tags is not communicated. For example, the information may describe the contextual tags, but not expose the exact wording of the contextual tags.

A third-party server 802 may select an appropriate instance of supplemental content for entities. For example, at 804, entities can generate instances of supplemental content for different contextual scenarios. Entities may then specify corresponding instances of supplemental content for the contextual scenarios. For example, entities may create segments that define conditions for respective instances of supplemental content. The conditions may include usage, confidence, affinity, or other conditions.

Also, supplemental content server 106 may receive the contextual tags 108 and targeted line items and contextual words 806 from a system. The targeted line items 806 may be guaranteed instances of supplemental content. Guaranteed may indicate that a certain number of impressions is guaranteed, such as the instance of supplemental content is guaranteed to be inserted 100,000 times. Supplemental content server 106 may select instances of supplemental content based on the available line items to meet the number of impressions.

A playstack 808 may represent logic in media player 112 that is used to play back the main content and the supplemental content. When playstack 808 encounters a supplemental content break, playstack 808 sends a request for supplemental content to supplemental content server 106. The request may include the main content entity ID and the time frame. The main content ID may identify the main content and the time frame may be a time during the playback, such as the time associated with a supplemental content break. Supplemental content server 106 may send the main content ID and time frame to contextual tags provider 108. Contextual tags provider 108 may then return the contextual tags associated with the main content ID and time frame.

Supplemental content server 106 may then select the instances of supplemental content for the break. For example, supplemental content server 106 may send information for the contextual tags to third-party server 802. Third-party server 802 will then select one or more instances of supplemental content based on the contextual tags provided, and return a response including the selected instances of supplemental content to supplemental content server 106. For example, third-party server 802 may compare the contextual tags to tags associated with instances of supplemental content to select an instance of supplemental content that includes the contextual tags. The instances of supplemental content may be prepared by entities to suit different contextual scenarios. The instances of supplemental content may be pre-qualified such that there is no real-time review of the instances of supplemental content by supplemental content server 106. Supplemental content server 106 also may make sure all contextual tags enabled supplemental content will be in “A” position-the first slot within a supplemental content break when there are multiple slots within a break. The technique to ensure “A” position may be an important callout because it may be the most effective if the contextually matched supplemental content is immediately after the main content stops and the break starts, or when the content is paused. By tagging supplemental content, supplemental content server 106 can include supplemental content pairing. In the supplemental content pairing case, if the second slot supplemental content is contextually relevant to the first slot supplemental content, then supplemental content server 106 can allow that placement as well.

Supplemental content server 106 sends information for the instances of supplemental content to playstack 808. Then, once receiving the response from supplemental content server 106, playstack 808 plays the instances of supplemental content.

### Programmatic Request Environment

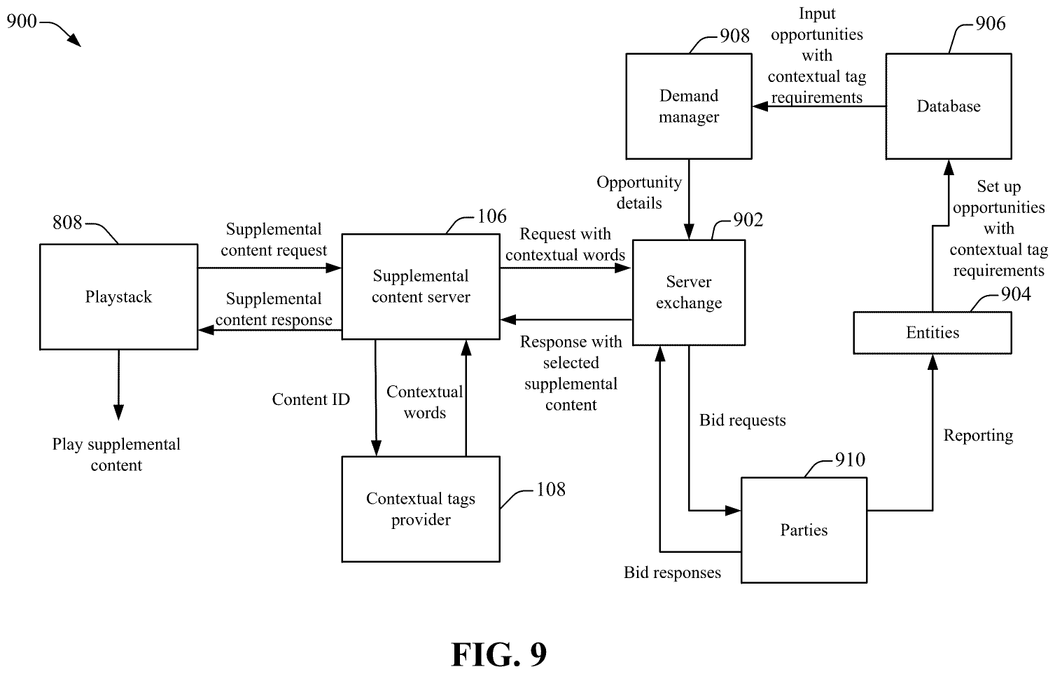

FIG. 9 depicts a simplified system 900 for processing programmatic requests according to some embodiments. Programmatic requests are where requests may be sent and requests are received to instances of supplemental content for a break. A demand manager 908 may set up opportunity details with an opportunity identifier. To set up the opportunity details, entities 904 may set up opportunities with contextual tag requirements in a database 906. Then, the opportunities with contextual tag requirements are input into demand manager 908. An example of an opportunity may be the contextual tags segment of “food” or “drinks”. When a server exchange 902 receives the request with contextual tags. Server exchange 902 may send requests to qualified items with the opportunity identifier. Then, parties 910 may send responses.

Playstack 808 sends a supplemental content request to supplemental content server 106 before a supplemental content break is encountered during playback. Supplemental content server 106 calls contextual tags provider 108 to retrieve corresponding contextual tags near this supplemental content break by its main content ID and supplemental content break offset timecodes. Supplemental content server 106 will then send the request to server exchange 902 including the information for the contextual tags. For opportunities that are not contextual tags enabled, server exchange 902 may send the qualified request to parties 910 as usual. For campaigns that are contextual tag enabled, the supplemental content server 106 may first receive the opportunity details from demand manager 908, and then qualify the request based on the contextual tag requirements specified in the opportunity set up. For example, if a deal specifies that it will only request on supplemental content opportunities that are near “food” OR “drinks” tags, server exchange 902 may send the request for this opportunity to a party if this supplemental content request has “food” OR “drinks” tag attached. Server exchange 902 may not send the contextual tags in the request to the party. The party sends the responses to server exchange 902. Server exchange 902 sends these responses with instances supplemental content back to supplemental content server 106 for decisioning. That is, supplemental content server 106 will select the winning request for supplemental content based on its current existing decisioning logic. Then, the instance of supplemental content is provided to playstack 808. The use of contextual tags allows distributed components in system 900 to make dynamic and faster real-time decisions on requests. This also reduces storage on the supplemental content server. The playback of the instance of supplemental content is also faster using the contextual tags to determine the instance of supplemental content.

### Direct Sold Supplemental Content

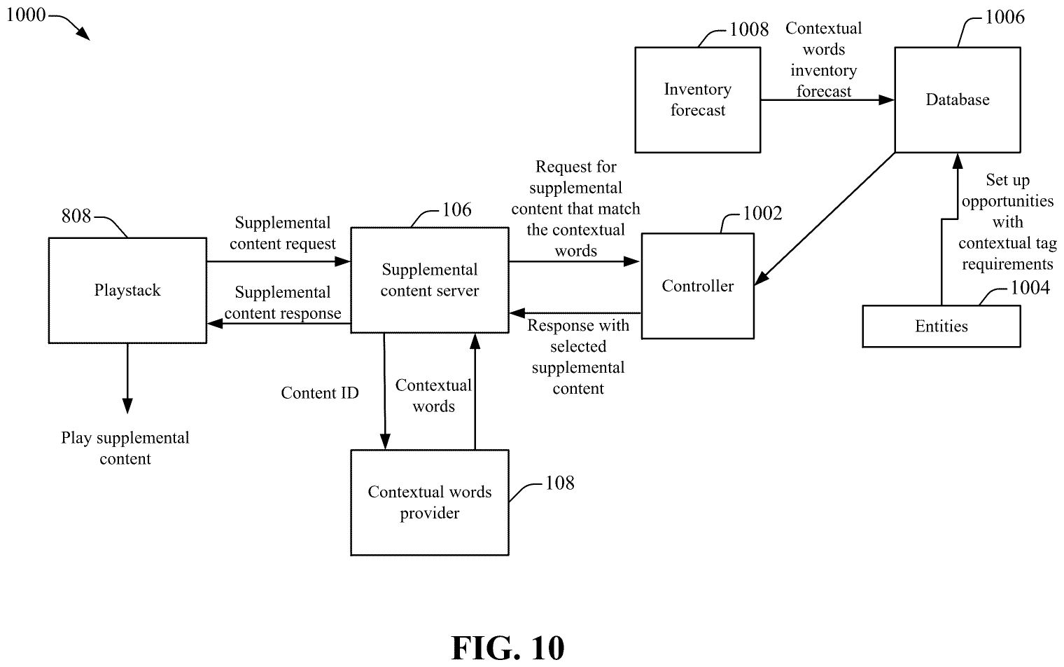

FIG. 10 depicts a simplified system 1000 for enabling contextual tags to be used in a direct request configuration according to some embodiments. A controller 1002 may coordinate the direct insertion of instances of supplemental content for a break. Entities and agencies may set up direct sold guaranteed deals in a database 1006. Database 1006 may use an inventory forecast to negotiate opportunities with the entities 1004. The opportunities may be input into database 1006. Then, controller 1002 receives the opportunities. Supplemental content server 106 sends a request to controller 1002 to retrieve the instance of supplemental content that match the contextual tags for the supplemental content break. For example, controller 1002 may compare the contextual tags to tags associated with instances of supplemental content to select an instance of supplemental content that includes the contextual tags. Controller 1002 returns all instances of supplemental content that match the contextual tags specified. Supplemental content server 106 receives the instances of supplemental content and can select the instances of supplemental content using a selection logic process. For example, the instance of supplemental content with the highest request value may be selected, but other methods may be used. Then, the instance of supplemental content is provided to playstack 808. The use of contextual tags allows distributed components in system 1000 to make dynamic and faster real-time decisions on requests. This also reduces storage on the supplemental content server. The playback of the instance of supplemental content is also faster using the contextual tags to determine the instance of supplemental content.

### Conclusion

Accordingly, the use of contextual tags may allow the contextual insertion of supplemental content. This increases the functionality of the supplemental content insertion system by allowing the insertion of content based on context rather than characteristics of the viewers of the instance of supplemental content. The use of relevance scores and confidence scores increases the relevancy of the context for contextual tags. Additionally, the affinity may also be used to provide other contexts, which improve the viewing experience.

### System

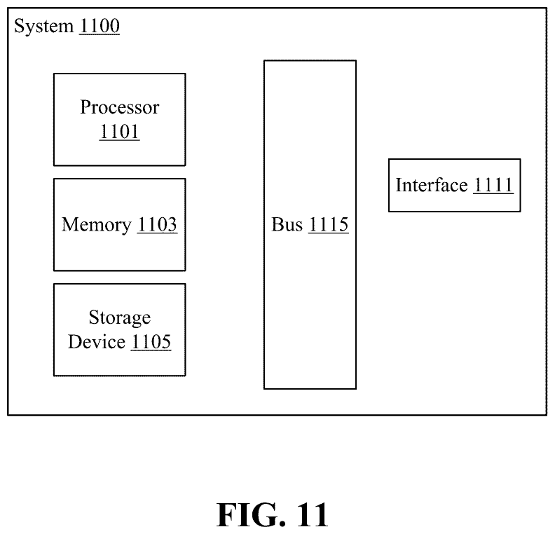

FIG. 11 illustrates one example of a computing device according to some embodiments. According to various embodiments, a system 1000 suitable for implementing embodiments described herein includes a processor 1001, a memory 1003, a storage device 1005, an interface 1011, and a bus 1015 (e.g., a PCI bus or other interconnection fabric.) System 1000 may operate as a variety of devices such as any device or service described herein. Although a particular configuration is described, a variety of alternative configurations are possible. The processor 1001 may perform operations such as those described herein. Instructions for performing such operations may be embodied in the memory 1003, on one or more non-transitory computer readable media, or on some other storage device. Various specially configured devices can also be used in place of or in addition to the processor 1001. Memory 1003 may be random access memory (RAM) or other dynamic storage devices. Storage device 1005 may include a non-transitory computer-readable storage medium holding information, instructions, or some combination thereof, for example instructions that when executed by the processor 1001, cause processor 1001 to be configured or operable to perform one or more operations of a method as described herein. Bus 1015 or other communication components may support communication of information within system 1000. The interface 1011 may be connected to bus 1015 and be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by non-transitory computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Java, Python, C++, C, HTML, any other markup language, JavaScript, ActiveX, VBScript, or Perl. Examples of non-transitory computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A non-transitory computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities. In some embodiments may be implemented in a non-transitory computer-readable storage medium for use by or in connection with the instruction execution system, apparatus, system, or machine. The computer-readable storage medium contains instructions for controlling a computer system to perform a method described by some embodiments. The computer system may include one or more computing devices. The instructions, when executed by one or more computer processors, may be configured or operable to perform that which is described in some embodiments.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of some embodiments may be implemented. The above examples and embodiments should not be deemed to be the only embodiments and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

What is claimed is:

1. A method comprising:
storing a set of tags from a taxonomy for a break in main content, wherein a portion of the main content within a time period threshold of the break is analyzed to determine the set of tags;
receiving an indication of the break that is going to be experienced during playback of main content, wherein a client device is playing back the main content;
responsive to the indication, retrieving the set of tags for the break;
providing information for the set of tags to a supplemental content system to facilitate selection of an instance of supplemental content based on the set of tags; and
providing information for the instance of supplemental content to the client device to insert the instance of supplemental content in the break during the playback of the main content.

2. The method of claim 1, wherein:
sets of tags are determined based on automatically analyzing different portions of main content corresponding to multiple breaks, and
the respective sets of tags are used to determine an instance of supplemental content for respective breaks.

3. The method of claim 1, further comprising:
inputting the portion of the main content into a machine learning process to predict the set of tags that are associated with the portion of main content.

3. The method of claim 3, wherein the machine learning process outputs a confidence score that indicates a confidence that the respective tag is detected in the portion of main content.

4. The method of claim 3, wherein the machine learning process outputs a relevance score that indicates a relevance that the respective tag is relevant to the portion of main content.

6. The method of claim 1, wherein a tag in the set of tags is based on a brand detected in the portion of main content.

7. The method of claim 1, further comprising:
assigning an affinity to tags in the set of tags based on a positive affinity or negative affinity to a category in the taxonomy, wherein the affinity is used to select the instance of supplemental content.

8. The method of claim 1, further comprising:
calculating a usage level for tags in the set of tags based on user accounts that viewed the main content, wherein the usage level is used to select the instance of supplemental content.

9. The method of claim 1, wherein selecting the instance of supplemental content comprises:
selecting the instance of supplemental content based on receiving the instance of supplemental content from a third party server, wherein an entity associated the instance of content with one of the set of tags.

10. The method of claim 9, wherein:
entities provide instances of supplemental content with associated tags in the taxonomy to the third party server,
the information for the set of tags is sent to the third party server for the break, and
the third party server automatically determines the instance of supplemental content based on comparing the information for the set of tags to the respective tags for the instances of supplemental content.

11. The method of claim 1, wherein selecting the instance of supplemental content comprises:
receiving a request from a party based on the set of tags.

12. The method of claim 11, wherein selecting the instance of supplemental content comprises:
sending a request for requests to a server exchange, wherein the server exchange determines parties to request on the break;
receiving a set of requests from the server exchange for a set of instances of supplemental content; and
selecting one of the requests in the set of requests, wherein the instance of supplemental content that is associated with the request is provided for insertion in the break.

13. The method of claim 12, wherein:
the server exchange determines which parties have instances of supplemental content that are associated with the set of tags, and
the server exchange sends the request for requests to the parties that are determined.

14. The method of claim 1, wherein selecting the instance of supplemental content comprises:
selecting the instance of supplemental content based on a condition for the instance of supplemental content matching the set of tags.

15. The method of claim 1, wherein selecting the instance of supplemental content comprises:
sending a request for items to a controller, wherein the controller determines instances of supplemental content that match the set of tags based on conditions specified by the items.

16. The method of claim 15, wherein the conditions include a confidence condition, a usage condition, or a combination of the confidence condition and the usage condition.

5. A non-transitory computer-readable storage medium having stored thereon computer executable instructions, which when executed by a computing device, cause the computing device to be operable for:
storing a set of tags from a taxonomy for a break in main content, wherein a portion of the main content within a time period threshold of the break is analyzed to determine the set of tags;
receiving an indication of the break that is going to be experienced during playback of main content, wherein a client device is playing back the main content;
responsive to the indication, retrieving the set of tags for the break;
providing information for the set of tags to a supplemental content system to facilitate selection of an instance of supplemental content based on the set of tags; and
providing information for the instance of supplemental content to the client device to insert the instance of supplemental content in the break during the playback of the main content.

18. The non-transitory computer-readable storage medium of claim 17, further operable for:
inputting the portion of the main content into a machine learning process to predict the set of tags that are associated with the portion of main content.

19. The non-transitory computer-readable storage medium of claim 17, wherein selecting the instance of supplemental content comprises:
selecting the instance of supplemental content based on receiving the instance of supplemental content from a third party server, wherein an entity associated the instance of content with one of the set of tags.

6. An apparatus comprising:
one or more computer processors; and
a computer-readable storage medium comprising instructions for controlling the one or more computer processors to be operable for:
storing a set of tags from a taxonomy for a break in main content, wherein a portion of the main content within a time period threshold of the break is analyzed to determine the set of tags;
receiving an indication of the break that is going to be experienced during playback of main content, wherein a client device is playing back the main content;
responsive to the indication, retrieving the set of tags for the break;
providing information for the set of tags to a supplemental content system to facilitate selection of an instance of supplemental content based on the set of tags; and
providing information for the instance of supplemental content to the client device to insert the instance of supplemental content in the break during the playback of the main content.
